(19) United States
(12) Patent Application Publication
(10) Pub. No.: US 2020/0342786 A1
(43) Pub. Date: Oct. 29, 2020

(54) Asthma Doll with Toy Breathing Machine

(71) Applicant: Tammy L. Moore, Midlothian, TX (US)

(72) Inventor: Tammy L. Moore, Midlothian, TX (US)

(21) Appl. No.: 16/396,076

(22) Filed: Apr. 26, 2019

(51) Int. Cl. G09B 23/30

(52) U.S. Cl. CPC G09B 23/30; A63H 3/001

(57) ABSTRACT

A doll for simulating asthma or other symptoms and responding to simulated treatment from an associated toy breathing machine includes a body and head including operating elements such as a programmer, transceiver, internal controller, speaker, microphone, skin element, and proximity sensor. The associated toy breathing machine generally includes a housing, tube, and mask, along with a proximity element. The doll is programmed by a user to simulate symptoms of an asthma attack and to recognize the proximity of the mask on the doll's face and to simulate the alleviation of symptoms. The doll may also simulate other illness symptoms, such as feverish temperature and red skin. The doll may include multiple proximity sensors and may recognize the proximity of toys including a toy inhaler, toy medicine dropper, toy blood oxygen monitor, and toy thermometer adjacent the respective proximity sensors.

### BACKGROUND

### 1. Field of the Invention

The present invention relates generally to improvements in toy dolls and training dummies, and more specifically to toy dolls and training dummies that simulate symptoms of asthma or other afflictions and respond to simulated treatments.

### 2. Description of Related Art

Young children with asthma sometimes have to be treated or examined at a doctor's office or at a hospital. Such children may often feel alienated and uncomfortable and may not fully understand their condition. While a variety of children's dolls are available as toys or companions for young children, and some of these dolls are capable or simulating or mimicking real behaviors, there is still a need for a doll specifically designed for young children with asthma or other afflictions.

Furthermore, treatment of asthma in very young children presents unique challenges and requirements as compared to the treatment in an older child or an adult. There is a need for a doll or dummy capable of simulating or mimicking a very young asthma patient for training purposes.

Although great strides have been made in the area of dolls and dummies that simulate or realistically mimic certain behaviors, many shortcomings remain.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of an asthma doll with a toy breathing machine according to the preferred embodiment of the present application, along with a storybook accessory;

FIG. 2 is a perspective view of an asthma doll with a toy breathing machine according to the present application, along with a wireless controller;

FIGS. 3-7 are perspective views of an asthma doll according to the present application, along with certain toy accessories; and

FIG. 8 is a perspective view of an asthma doll according to the present application in a pull-up clothing article.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, combinations, and alternatives falling within the spirit and scope of the present application as defined by the appended claims.

### DETAILED DESCRIPTION OF THE PREFERRED EMBODIMENT

Illustrative embodiments of the asthma doll with toy breathing machine according to the present application are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

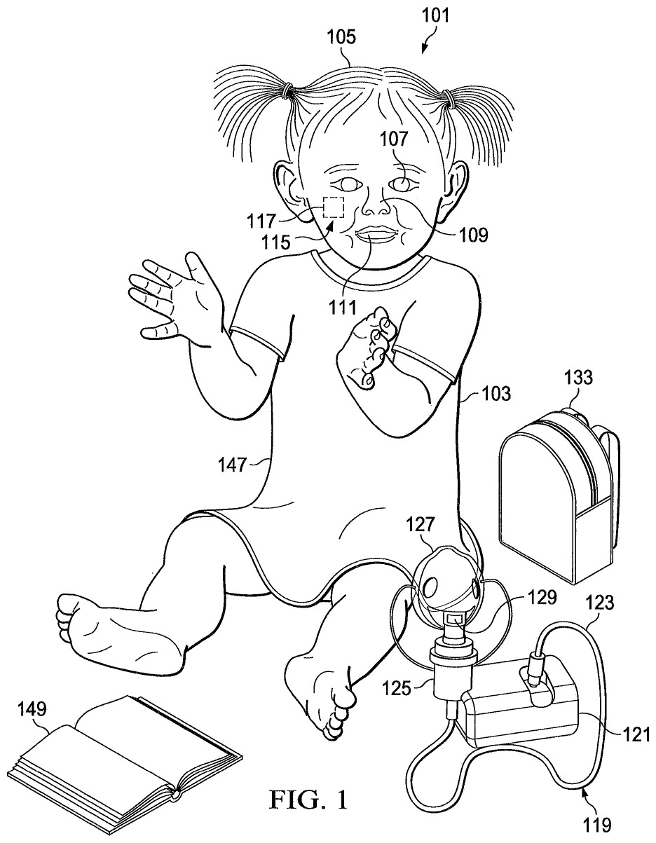

Referring now to FIG. 1, a perspective view of an asthma doll 101 along with a toy breathing machine 119 and certain other accessories is shown. Doll 101 preferably resembles a toddler in size and appearance and preferably is dressed in a hospital gown 147. As depicted, doll 101 is shown to resemble a female toddler, but it should be understood that the embodiment of doll 101 is not limited to a particular gender, age, or other visible characteristics. Doll 101 should be understood to preferably include an inner structure such that the limbs and joints of doll 101 articulate and flex similarly to genuine human movement.

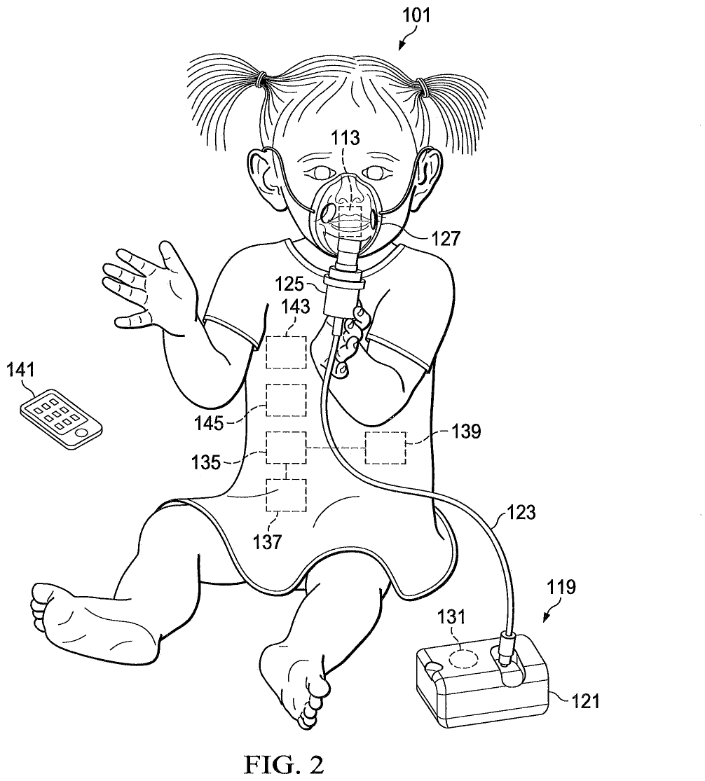

Referring now also to FIG. 2, doll 101 generally comprises a body 103, a head 105, and a programmer 135 held within body 103. Head 105 has several features which preferably are used to simulate symptoms, including eyes 107, nose 109, and mouth 111. A proximity sensor 113 is generally located within or adjacent mouth 111 in head 105 (see FIG. 2). At least head 105 further comprises skin 115 which is a realistic skin-like material that, along with a skin element 117, accurately mimics human skin and asthma symptoms or other symptoms typically observable in skin. Doll 101 preferably simulates realistic symptoms and responds to simulated treatment of those symptoms as described below.

A toy breathing machine 119 preferably accompanies and interacts with doll 101 and mimics the appearance and operation of a medicine nebulizer or vaporizer. Toy breathing machine 119 generally comprises a housing 121, a tube 123, a cup 125, and a mask 127. A proximity element 129 is preferably contained within mask 127 such that proximity element 129 is held adjacent or near proximity sensor 113 when mask 127 is placed on doll 101. A vapor simulation element 131 preferably is located within housing 121 and operates to create or simulate visible vapor in at least mask 127 and cup 125 and preferably also in tube 123. The operation of toy breathing machine 119 and its interaction with doll 101 is described below. Toy breathing machine 119 is carried in a carrier bag 133. Carrier bag. 133 is preferably a backpack that is sized and shaped to store toy breathing machine 119 and to fit on the back of doll 101, but it should be understood that carrier bag 133 may be of any shape and design suitable for storing and carrying toy breathing machine 119.

Doll 101 and its symptom simulation and interactivity with toy breathing machine 119 or with a user is generally controlled by programmer 135 held within body 103 of doll 101. Programmer 135 preferably is a specialized electronic computer that may be programmed to operate in certain ways specified by a user or manufacturer. For example, programmer 135 preferably is in communication with a transceiver 137 and an internal controller 139 within body 103 of doll 101. Electronic computerized programmers, transceivers, and electronic controllers are elements that are generally well known and understood in the art and, as such, are shown in FIG. 2 as dashed elements generally located within body 103. As shown in FIG. 2, transceiver 137 and internal controller 139 are connected to but separate from programmer 135; however, it should be understood that transceiver 137 and internal controller 139 may be separate elements as shown, or may be integral elements of programmer 135.

Programmer 135 preferably also communicates with a wireless controller 141 via transceiver 137. As depicted in FIG. 2, wireless controller 141 is embodied as an app installed on a smartphone, but it should be understood that wireless controller 141 may comprise any combination of hardware and software capable of communicating with programmer 135 for controlling and programming doll 101, such as a dedicated wireless controller. Programmer 135 preferably is also connected to at least one speaker 143 and at least one microphone 145 held within doll 101. Speaker 143 and microphone 145 are well understood elements shown generally as dashed elements within body 103, but it should be understood that doll 101 may comprise multiple speakers 143 and multiple microphones 145, and that speakers 143 and 145 may be located at any location within doll 101. For example, a speaker 143 may be positioned in head 105 such that it simulates a voice from mouth 111.

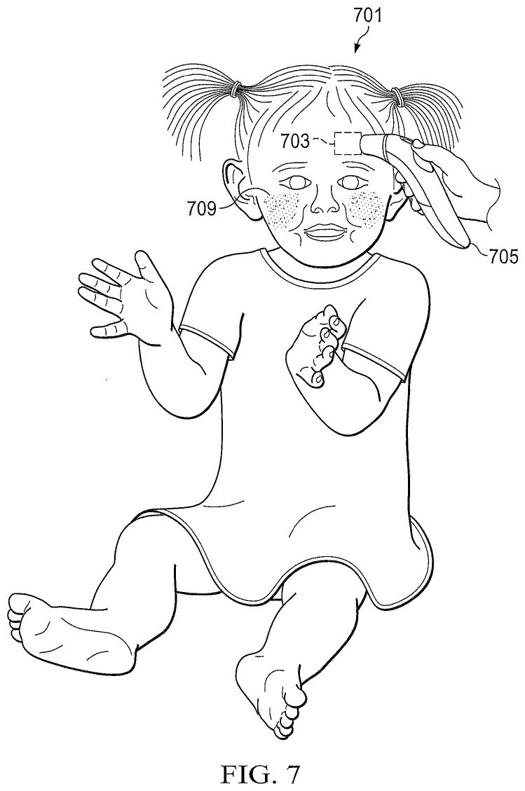

Doll 101 preferably is programmed by programmer 135 to simulate realistic symptoms of an illness or affliction, preferably asthma, according to the preferred embodiment of the present application. For example, as disclosed above, doll 101 includes skin 115 and a skin element 117 which may simulate symptoms such as skin 115 turning red or blue (see FIG. 7, for example, showing doll 701 with skin coloration 709 on cheeks). Skin 115 is a realistic skin-like material that appears and feels like human skin, and skin 115 preferably may turn various shades of red or blue to simulate symptoms such as choking or difficulty breathing. For example, skin 115 may be coated with a thermally-reactive color-changing substance that is not noticeable when skin 115 is at a normal room temperature, but changes color when skin 115 is heated. When skin element 117 comprises a heating element, programmer 135 may therefore cause skin element 117 to safely heat skin 115 about skin element 117 and skin 115 may turn a shade of red, blue, or another desired color thereby simulating symptoms of asthma or choking. Alternatively, skin 115 may not include a thermally-reactive substance and may instead be a translucent material and skin element 117 may comprise colored LED lights. In such an embodiment, skin element 117 preferably is not visible through skin 115 at any time, but the colored light from skin element 117 in combination with translucent skin 115 may cause skin 115 to visibly change colors when skin element 117 is activated by programmer 135, thereby simulating an asthma attack or choking.

The thermally-activated embodiment and the colored-LED embodiment as described above are just two example embodiments of skin 115 and skin element 117 contemplated by the present application. Other designs that cause skin 115 to change color in order to simulate symptoms may be used. FIG. 1 shows only a single skin element 117 represented generally by a dashed outline in the face of head 105, but it should be understood that doll 101 may include multiple skin elements 117 in various locations within head 105 to simulate symptoms. For example, skin elements may be located in the cheeks of head 105 that turn generally red or dark red while a distinct skin element is located adjacent mouth 111 that turns the lips of mouth 111 dark blue to visibly indicate a lack of oxygen in doll 101. Furthermore, as disclosed above, skin 115 is preferably used at least on head 105 of doll 101. Body 103 preferably comprises any acceptable material for creating a doll 101 including various plastics, polymers, or composites, but body 103 may in some embodiments comprise a realistic skin-like substance such as skin 115 along with head 105, and skin elements 117 may be present within the body 103 of doll 101 according to design objectives of a user or manufacturer.

As disclosed above, skin elements 117 preferably interact with skin 115 to visibly mimic symptoms of an asthma attack or choking. It should be understood that skin elements 117 may be utilized in various forms with specific components of head 105 to mimic specific symptoms. For example, as provided above, skin elements 117 may be specifically located adjacent mouth 111 to turn the lips of mouth 111 blue. Additionally, skin elements 117 may be located adjacent nose 109 or eyes 107 to turn the skin about nose 109 or to turn eyes 107 a desired color in order to simulate symptoms.

As provided above, programmer 135 preferably is connected to at least one speaker 143. Programmer 135 preferably is programmed to play sounds associated with an asthma attack while skin 115 is visibly displaying visual symptoms as described above. For example, programmer 135 may cause speaker 143 to play crying or wheezing sounds. Programmer 135 preferably is programmed to recognize simulated treatment as provided below, and preferably is programmed to escalate the symptoms exhibited by doll 101 the longer doll 101 goes without simulated treatment. For example, programmer 135 may initially cause speaker 143 to play crying sounds while skin elements 117 cause skin 115 to turn red, and after a selected length of time without simulated treatment, may cause speaker 143 to play wheezing and coughing sounds and cause skin 115 to turn darker shades of red or blue to simulate worsening symptoms.

The timing and severity of simulated asthma attacks in doll 101 may be controlled by a user in various ways, including selectively initiating a simulated attack via internal controller 139 or wireless controller 141, setting simulated attacks on a timer with internal controller 139 or wireless controller 141, or setting simulated attacks to occur randomly with an internal controller 139 or wireless controller 141.

Alternatively, doll 101 may also be programmed to recognize user activity and may be programmed to simulate symptoms only when a user is actively playing with or using doll 101. For example, doll 101 preferably includes a microphone 145, and programmer 135 may be programmed to recognize specific auditory inputs or commands via microphone 145 which instruct programmer 135 to begin or set a time to begin simulation of symptoms. For example, a user may issue verbal commands that cause doll 101 to simulate an asthma attack immediately, at a specified time, or randomly. Alternatively, rather than simulating symptoms in response to specific audio cues, programmer 135 may be programmed to simply hear activity about doll 101 via microphone 145 and to randomly simulate symptoms when activity is detected about doll 101. Alternative embodiments of doll 101 may utilize other elements that allow programmer 135 to detect activity, such as ambient light sensors or motion sensors.

As disclosed above, doll 101 preferably comprises an internal controller 139 and includes a wireless controller 141. Internal controller 139 may or may not include a user interface, depending on the design preferences for doll 101. For example, doll 101 may be programmable by a user without wireless controller 141. In such an embodiment, body 103 preferably includes an access panel or opening such that a user may access internal controller 139 to control doll 101, and internal controller 139 may include physical connective elements, such as a USB-type port such that a user could install software updates or programmed commands into programmer 135. In such an embodiment, wireless controller 141 may not be necessary for a user to have full use and functionality of doll 101.

Alternatively, internal controller 139 and wireless controller 141 may control separate distinguishable programming criteria of doll 101, and internal controller 139 may not be easily accessible to a user. For example, as illustrated in FIG. 2, internal controller 139 is an element of programmer 135 that controls the simulation of symptoms in doll 101 in response to auditory commands as described above while wireless controller 141, shown as an app-enabled smartphone, allows a user to issue specific commands to doll 101. As disclosed above, programmer 135 communicates with wireless controller 141 via at least one transceiver 137, which may be accomplished in any appropriate or desirable way. For example, programmer 135 may utilize transceivers 137 to communicate with wireless controller 141 via Bluetooth, over a local WiFi network, or via radio waves or other frequencies. Wireless controller 141 accordingly may comprise an app-enable smartphone as illustrated, or may comprise a distinct and dedicated radio, Bluetooth, or WiFi-capable controller. In an embodiment of doll 101 having WiFi connectivity, a user may use wireless controller 141 to command programmer 135 to download software updates or settings directly from the internet.

Programmer 135 may send data and feedback to wireless controller 141 such that a user has a record of simulated asthma attacks and treatments and may indicate proper or improper treatment of the simulated symptoms. Wireless controller 141, as an app-enabled smartphone, may also include training materials and videos for training or teaching a user of doll 101 about the symptoms displayed by doll 101 and the treatment given.

As shown in FIG. 1, doll 101 preferably includes a book 149 which may be embodied in a variety of ways depending on the specific embodiment and use of doll 101. For example, when accompanying a doll 101 meant for training parents or medical personnel on the proper method of care for an asthmatic child or toddler, book 149 may be a medical training manual and may include operating instructions for doll 101. Alternatively, in an embodiment of doll 101 meant to be a companion for young children, book 149 may comprise a storybook that preferably includes a written and illustrated story including specific key phrases to be read aloud that, as disclosed above, verbally command doll 101 to simulate specific symptoms.

As provided above, toy breathing machine 119 preferably mimics the operation of a medicine nebulizer or vaporizer and interacts with doll 101 to simulate treatment of symptoms. Doll 101 preferably includes at least one proximity sensor 113 and preferably locates it adjacent or in mouth 111. Proximity sensor 113 may be any variety of proximity sensor well known and understood in the art capable of detecting the near presence of a specific proximity element. A proximity element 129 is preferably located in mask 127 and is uniquely recognizable by proximity sensor 113. For example, proximity element 129 may comprise a unique RFID, electronic, or magnetic element. In operation by a user, when programmer 135 is causing doll 101 to simulate physical symptoms of an asthma attack such as discoloration in skin 115 and auditory symptoms such as crying, wheezing, or coughing played from speaker 143, a user will place mask 127 onto the face of doll 101 adjacent mouth 111 and nose 109. Programmer 135 is connected to and in communication with proximity sensor 113 which detects proximity element 129, and programmer 135 is programmed to receive a signal from proximity sensor 113 and recognize that signal as indicating that mask 127 has been properly placed on doll 101. Programmer 135 then causes doll 101 to simulate alleviated or subsiding symptoms.

In an embodiment of toy breathing machine 119 wherein proximity element 129 is a simple magnetic or RFID tag element, simple proximity between proximity element 129 and proximity sensor 113 is sufficient to cause proximity sensor 113 to signal programmer 135 that mask 127 is properly placed on doll 101. However, in alternative embodiments of doll 101 and toy breathing machine 119, further user action may be required. For example, as disclosed below, toy breathing machine 119 preferably simulates an operating medicine nebulizer and as such may be switched on and off. A toy breathing machine 119 may be modified such that proximity element 129 is electronically controlled and operated to send a weak wireless signal recognizable by proximity sensor 113 only after a user places mask 127 on doll 101 and turns on toy breathing machine 119.

Toy breathing machine 119 preferably simulates the operation of a medicine nebulizer. As shown in FIG. 2, vapor simulation element 131 is shown generally as a dashed outline within housing 121. It should be understood that vapor simulation element 131 may embody any suitable form for simulating vapor in toy breathing machine 119 and may be located within toy breathing machine 119 wherever suitable or necessary for simulating vapor. In one embodiment, vapor simulation element 131 comprises a functional vaporizer or steam element within housing 121 that includes a fluid reservoir in housing 121 and generates vapor or mist and disperses it through tube 123 and cup 125 and out of mask 127. Alternatively, mask 127 may comprise a transparent hollow shell and cup 125 and tube 123 may include a return element such that vapor simulation element 131 instead recirculates vapor or mist through toy breathing machine 119 and no mist or vapor is actually expelled from mask 127. Also alternatively, vapor simulation element 131 may instead be held within cup 125 including a fluid reservoir such that vapor simulation element 131 expels vapor or mist from mask 137 or recirculates vapor of mist within mask 127 without any vapor or mist being present in housing 121 of tube 123.

Other embodiments of toy breathing machine 119 and vapor simulation element 131 may not utilize any actual vapor or mist. For example, vapor simulation element 131 may comprise a string of small LED lights extending inside tube 123 through cup 125 into mask 127, and housing 121 may contain a rechargeable battery pack or a bay of disposable batteries to operate the LED lights of vapor simulation element 131. In such an embodiment, housing 121 further contains a programmer that causes the LED lights of vapor simulation element 131 to light up in a sequence illustrating or indicating the movement of vapor through toy breathing machine 119.

Toy breathing machine 119 may also simulate other observable functions simulating operation of a medicine nebulizer or vaporizer. For example, toy breathing machine 119 may include speakers which play vaporizer or compressor sounds, and toy breathing machine 119 may include a vibrating element such as a rotating non-balanced mass that cause housing 121 to slightly vibrate. Such simulation element would be useful in an embodiment of toy breathing machine that does not actually produce vapor or mist, such as the embodiment utilizing strings of LED lights as disclosed above, but could also be utilized to augment the simulation in an embodiment of toy breathing machine 119 that does actually expel or recirculate mist or vapor as disclosed above. The operation of toy breathing machine preferably is selectively turned on and off by a user via a switch or button (not shown) on housing 121.

As provided above, toy breathing machine 119 may be powered be a rechargeable battery pack within housing 121 or may be powered be disposable batteries held in housing 121, and turning on toy breathing machine 119 may also power a proximity element 129. In operation, when doll 101 is simulating symptoms of an asthma attack, a user preferably places mask 127 onto the face of doll 101 adjacent mouth 111 and nose 109 and turns on toy breathing machine 119, thereby simulating treatment of doll 101.

As disclosed above, certain elements of doll 101 and toy breathing machine 119 have specific material property requirements. For example, skin 115 preferably realistically looks like and feels like human skin, and may be translucent to such a degree that a skin element 117 comprising colored LED lights is not visible beneath skin 115 but causes skin 115 to visibly change color when operated, and mask 127 and tube 123 are preferably is a transparent or translucent flexible material such that simulated vapor or mist is visible within toy breathing machine 119. It should be understood that elements disclosed above that otherwise are not limited to any specific material property requirements may comprise any material suitable for meeting the manufacturing, design, and user objectives. For example, the elements may include metal, plastic, polymer, rubber, or composite materials as required for the proper function of doll 101 and toy breathing machine 119 in realistically simulating symptoms of an asthma attack in a toddler or young child and its treatment.

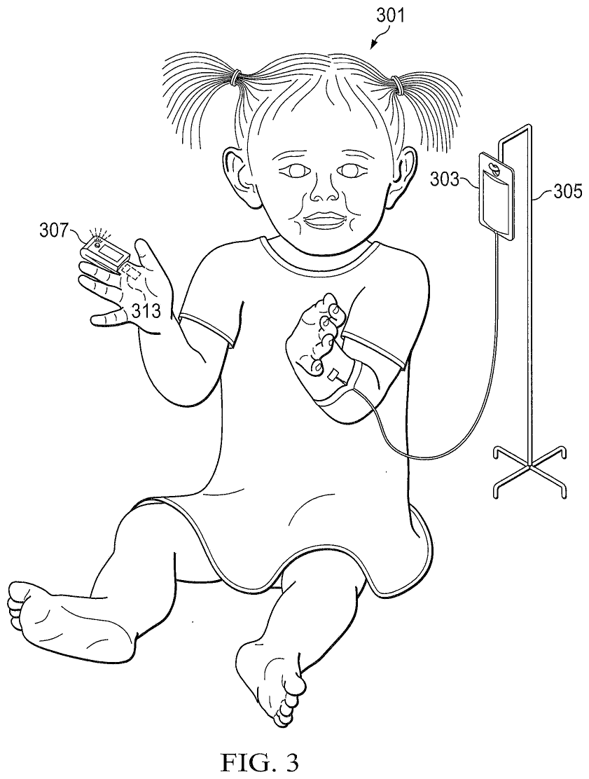

Referring now also to FIG. 3, a doll 301 is shown with associated toys including a toy IV bag 303 on toy IV stand 305 and a toy blood oxygen monitor 307. Doll 301 should be understood to be the same as or substantially similar to doll 101 unless otherwise specified herein. Toy IV bag 303 is shown, along with toy IV stand 305, as a toy that may be utilized with doll 101 or 301. It should be understood that, in a doll 301 intended for children toy IV bag 303 has a tube and a flexible fake IV end that is not actually sharp. Alternatively though, in an embodiment of doll 301 intended for training medical personnel, the body of doll 301 may be covered in a realistic skin-like material in addition to the head, and toy IV bag 303 may include a needle end sharp enough to puncture the skin of doll 301.

Doll 301 includes the elements of doll 101, and further includes at least one proximity sensor 313 located in a hand of doll 101 for use with a toy blood oxygen monitor 307. Proximity sensor 313 should be understood to be the same as or substantially similar to proximity sensor 113, including all its disclosed embodiments, and is connected to and in communication with the programmer in doll 301 like programmer 135 in doll 101. Toy blood oxygen monitor 307 preferably is a battery powered toy that includes at least a proximity element 309 (not shown) and may also include transceiver 311 (not shown). Proximity element 309 should be understood to be the same as or substantially similar to proximity element 129, including all its disclosed embodiments. Similarly to the operation of proximity sensor 113 and proximity element 129 disclosed above, the programmer of doll 301 is programmed to simulate physical illness symptoms such as symptoms of an asthma attack.

The programmer of doll 301 preferably recognizes the presence of toy blood oxygen monitor 307 on the hand of doll 301 adjacent proximity sensor 313 and may be programmed to perform certain functions. For example, toy blood oxygen monitor 307 is preferably a battery powered electronic toy including a transceiver 311 such that the programmer of doll 301 communicates with toy blood oxygen monitor 307 and causes toy blood oxygen monitor 307 to display certain blood oxygen values. When doll 301 is simulating symptoms of an asthma attack and before a user has placed a mask such as mask 127 onto doll 301, the programmer of doll 301 may cause toy blood oxygen monitor 307 to display poor blood oxygen levels, and may cause toy blood oxygen monitor 307 to display improving blood oxygen levels after a user properly places a mask such as mask 127 onto doll 301.

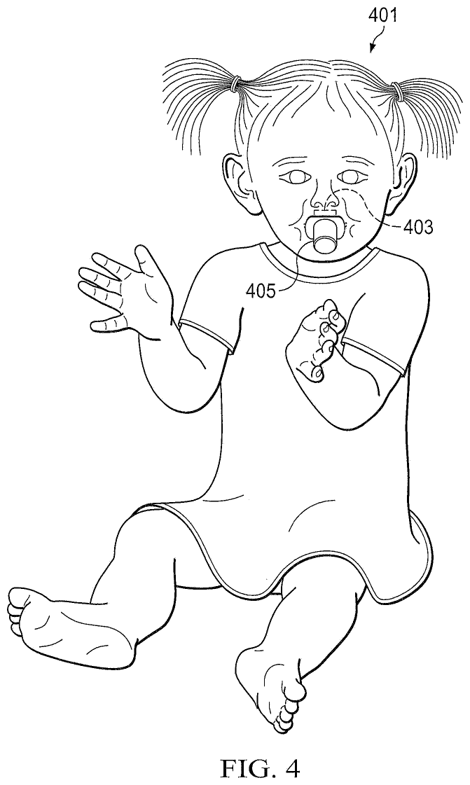

Referring now also to FIG. 4, a doll 401 is shown with an associated toy pacifier medicine dropper 405. Doll 401 should be understood to be the same as or substantially similar to doll 101 unless otherwise specified herein. Doll 401 includes a proximity sensor 403 similar to proximity sensor 113 in doll 101. Toy pacifier medicine dropper 405 includes a proximity element 407 (not shown). The programmer in doll 401 like programmer 135 in doll 101 may be programmed to simulate certain illness symptoms other than asthma. For example, doll 401 could use skin elements like the heating embodiments of skin element 117 disclosed above to warm the skin of doll 401 simulating a fever, and the programmer of doll 401 could utilize a speaker like speaker 143 to play crying sounds. Furthermore, doll 401 could communicate with a wireless controller like the app-enabled smartphone embodiment of wireless controller 141 to inform a user that doll 401 has a fever and needs medicine. The user then preferably places toy pacifier medicine dropper 405 into the mouth of doll 401, such that proximity element 407 is adjacent proximity sensor 403, and the programmer of doll 401 would then recognize that a user has simulated giving medicine to doll 401 and react according to its programmed responses.

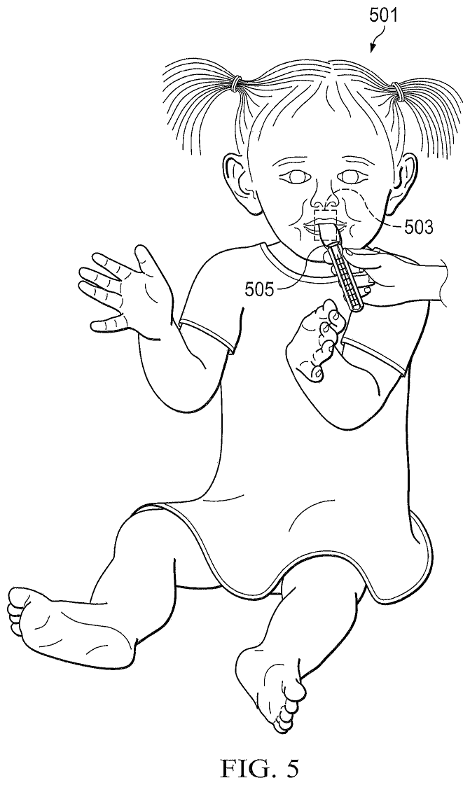

Referring now also to FIG. 5, a doll 501 is shown with an associated toy medicine dropper 505. Doll 501 should be understood to be the same as or substantially similar to doll 401 described above, and doll 501 should be understood to include a proximity sensor 503 adjacent the mouth of doll 501 like proximity sensors 403 and 113. Toy medicine dropper 505 includes a proximity element 507 (no shown) such that the programmer of doll 501, when simulating a physical illness, recognizes that a user has simulated treatment with toy medicine dropper 505 similarly to how the programmer of doll 401 recognizes simulated treatment with toy pacifier medicine dropper 405.

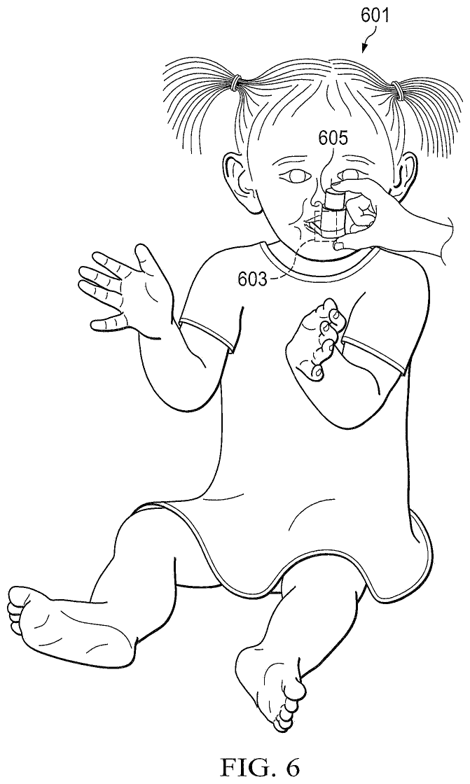

Referring now also to FIG. 6, a doll 601 is shown with an associated toy inhaler 605. Doll 601 should be understood to be the same as or substantially similar to doll 101 except as otherwise specified here. Doll 601 includes a proximity sensor 603 like proximity sensor 113 in doll 101, or alternatively proximity sensor 603 as shown in FIG. 6 represents proximity sensor 113. Toy inhaler 605 includes a proximity element 607 (not shown) which is a unique proximity element like proximity element 129, and it should be understood that the programmer of doll 601 like programmer 135 causes doll 601 to simulate symptoms of an asthma attack and that the programmer of doll 601 recognizes when a simulated treatment has been administered with toy inhaler 605 be detecting the presence of toy inhaler 605 adjacent the mouth of doll 601 in response to simulated symptoms. Alternatively, doll 601 may communicate with a wireless controller like wireless controller 141 to notify a user that doll 601 needs toy inhaler 605.

In order for a young child to learn to properly use an inhaler, toy inhaler 605 may be an electronic battery-operated toy that only causes proximity element 607 (not shown) to produce a signal when toy inhaler 605 is actually properly depressed. In such an embodiment, proximity element 607 is similar to the electronic short-wireless-signal embodiment of proximity element 129 disclosed above.

Referring now also to FIG. 7, a doll 701 is shown with an associated toy thermometer 705. Doll 701 should be understood to be the same as or substantially similar to dolls 101 or 401 disclosed above except as otherwise specified here. Doll 701 may comprise a proximity sensor 703 located in the forehead of doll 701, and toy thermometer 705 may be a battery-operated toy that includes a proximity element 707 (not shown) like proximity element 129 and may also include a transceiver such that the programmer of doll 701, when simulating fever symptoms as described above, recognizes that a user has placed toy thermometer 705 adjacent proximity sensor 703 and communicates with toy thermometer 705 to cause toy thermometer 705 to display an elevated body temperature. Alternatively, doll 701 may include skin elements similar to the heating embodiment of skin elements 117 disclosed above such that the skin of doll 701 actually raises to a realistic fever temperature such that an actual thermometer like an infrared thermometer accurately indicates a fever. Furthermore, like doll 101, doll 701 may display skin coloration to simulate symptoms. FIG. 7 shows doll 701 having skin coloration 709 on the cheeks of doll 701, which should be understood to be red coloration indicating a fever.

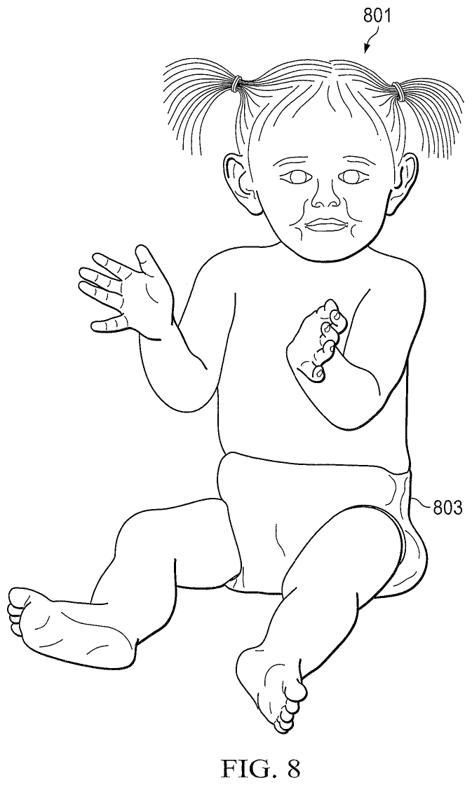

Referring now to FIG. 8, a doll 801 is shown. Doll 801 should be understood to be the same as or substantially similar to any of dolls 101, 301, 401, 501, 601, or 701, except that dolls 101, 301, 401, 501, 601, and 701 are shown as preferably being dressed in a toddler-sized hospital gown. Doll 801 though is dressed in a toddler-sized pull-up type undergarment.

It is apparent that a doll and system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered, combined, and/or modified, and all such variations are considered within the scope and spirit of the application. Accordingly, the protection sought herein is as set forth in the description and claims. Although the present embodiments are shown above, they are not limited to just these embodiments, but are amenable to various changes and modifications without departing from the spirit thereof.

I claim:

1. A doll for simulating asthma symptoms and responding to simulated treatment of those symptoms, the doll comprising:
a body containing an internal controller and a programmer;
a head including eyes, a nose, and a mouth;
a realistic skin-like material on the surface of the head; and
a first proximity sensor within the head adjacent the mouth;
wherein the programmer selectively causes the doll to simulate asthma symptoms;
wherein the first proximity sensor detects the presence of a first proximity element adjacent the first proximity sensor and sends a first signal to the programmer; and
wherein the programmer communicates with the first proximity sensor such that the programmer receives the first signal and gradually reduces the asthma symptoms.

2. The doll according to claim 1, further comprising:
a speaker located within the body and in communication with the programmer, such that the programmer causes the speaker to selectively play sounds;
wherein the programmer causes the speaker to play sounds simulating an asthma attack when the programmer causes the doll to simulate asthma symptoms;

3. The doll according to claim 1, further comprising:
a microphone located within the body and in communication with the programmer;
wherein the microphone detects specific audio cues and relays them to the programmer; and
wherein the programmer recognizes the specific audio cues and causes the doll to simulate asthma symptoms in response to the specific audio cues.

4. The doll according to claim 1, further comprising:
a heating skin element beneath the realistic skin-like material in the head, the heating skin element being connected to the programmer;
wherein the realistic skin-like material comprises:
a thermally-reactive material such that the realistic skin-like material changes color in response to heat from the heating skin element;
wherein the programmer communicates with the heating skin element and causes it to heat the realistic skin-like material when the programmer causes the doll to simulate asthma symptoms.

5. The doll according to claim 1, further comprising:
a colored-lighting skin element beneath the realistic skin-like material in the head, the colored-lighting element being connected to the programmer;
wherein the realistic skin-like material comprises a translucent material such that the realistic skin-like material changes color in response to colored light from the colored-lighting skin element; and
wherein the programmer communicates with the colored-lighting skin element and causes it to output colored light into the realistic skin-like material when the programmer causes the doll to simulate asthma symptoms.

6. The doll according to claim 1, wherein the first proximity element is located in a mask of a toy breathing machine such that the programmer receives the first signal when the mask is adjacent the first proximity sensor.

7. The doll according to claim 1, wherein the first proximity element is located in a toy inhaler such that the programmer receives the first signal when the toy inhaler is adjacent the first proximity sensor.

8. The doll according to claim 1, further comprising:
a second proximity sensor located in a hand of the doll and in communication with the programmer; and
a first transceiver connected to and in communication with the programmer;
wherein the second proximity sensor detects the presence of a second proximity element adjacent the second proximity sensor and sends a second signal to the programmer;
wherein the second proximity element is located within a toy having a battery, a screen, and a second transceiver; and
wherein the programmer communicates with the second proximity sensor such that the programmer receives the second signal and uses the first transceiver to wirelessly communicate with the second transceiver in the toy to cause the toy to display a specific output on the screen.

9. A toy breathing machine for association with a doll simulating asthma symptoms and responding to simulating treatment, the toy breathing machine comprising:
a housing containing a battery, a programmer, and a switch that selectively switches between an on position and an off position;
a cup attached to a transparent mask;
a transparent tube extending between the cup and the housing;
a vapor simulation element; and
a proximity element on the transparent mask;
wherein the programmer causes the vapor simulation element to simulate vapor at least within the mask when switched is placed into the on position; and
wherein the proximity element is uniquely identifiable to an associated proximity sensor in the doll.

10. The toy breathing machine according to claim 9, wherein the vapor simulation element comprises:
a vaporizer and a fluid reservoir located within the cup such that vapor actually exits the transparent mask.

11. The toy breathing machine according to claim 9, wherein the vapor simulation element comprises:
a vaporizer; and
a fluid reservoir located within the housing such that vapor actually flows through the transparent tube and the cup and exits the transparent mask.

12. The toy breathing machine according to claim 9, wherein the vapor simulation element comprises:
a vaporizer; and
a fluid reservoir;
wherein the transparent mask is a transparent shell with a supply connection and a return connection to the vapor simulation element such that vapor recirculates between the vapor simulation element and the transparent mask.

13. The toy breathing machine according to claim 9, wherein the vapor simulation element comprises;
a string of LED lights extending through the tube and cup and into the transparent mask, the programmer selectively lighting certain of the LED lights to visually indicate flow through the toy breathing machine.

14. The toy breathing machine according to claim 9, further comprising:
a speaker and a vibration element within the housing;
wherein the speaker and the vibration element together simulate a running compressor when the switch is in the on position.
